(19) United States
(12) Patent Application Publication
(10) Pub. No.: US 2022/0141778 A1
(43) Pub. Date: May 5, 2022

(54) Information Obtaining Method and Terminal Device

(71) Applicant: Huawei Technologies Co., Ltd., Shenzhen (CN)

(72) Inventors: Tongbo Wang, Shanghai (CN); Liping Wang, Wuhan (CN)

(21) Appl. No.: 17/432,352

(22) PCT Filed: Feb. 20, 2019
(86) PCT No.: PCT/CN2019/075614

§ 371 Date: Aug. 19, 2021

(51) Int. Cl. H04W 52/28; H04W 48/16; H04W 52/16

(52) U.S. Cl. CPC H04W 52/283; H04W 52/16; H04W 48/16

(57) ABSTRACT

Embodiments of this application provide an information obtaining method and a terminal device. The method is applicable to a device having a wireless fidelity Wi-Fi function. When the terminal device cannot be connected to a cellular network, the method includes: The terminal device configures at least one first channel and a transmit power of each first channel, searches for an access point device on a corresponding first channel by using a configured transmit power, completes an access connection to a found access point device, obtains a current geographic location of the terminal device based on a media access control MAC address of the access point device connected by the terminal device, and obtains country information (for example, a country code) based on the geographic location. Alternatively, the terminal device locates a current geographic location of the terminal device by using a built-in positioning module, and obtains corresponding country information (for example, a country code) based on the geographic location, so that the terminal device subsequently configures a correct transmit power and a correct channel for Wi-Fi based on the country code.

### TECHNICAL FIELD

This application relates to the communications field, and in particular, to an information obtaining method and a terminal device.

### BACKGROUND

Different countries require different transmit powers and different channel requirements for wireless fidelity (wireless-fidelity, Wi-Fi). When transmitting a Wi-Fi signal, a terminal device needs to identify, by using a country code, a country in which the terminal device is currently located, and transmits the Wi-Fi signal on a specified channel by using a specified transmit power according to a requirement corresponding to the country. Currently, the terminal device identifies a corresponding country code through a cellular network. When the terminal device cannot identify the country code through the cellular network, a country code corresponding to a language and region/country that is preset by the terminal device is, by default, a country code of a country in which the terminal device is currently located, or a country code corresponding to the transmit power that is used to transmit the Wi-Fi signal when the terminal device identifies a network last time is, by default, a country code of a country in which the terminal device is currently located.

When the terminal device cannot identify the country code through the cellular network, although the terminal can also obtain the country code, the terminal cannot accurately learn of the country in which the terminal device is currently located, and a chip of the terminal device cannot configure a transmit power and a channel by using a correct country code. As a result, the transmit power and the channel are incorrect.

### SUMMARY

Embodiments of this application provide an information obtaining method and a terminal device, to resolve a problem that a transmit power and a channel are incorrectly configured because the terminal device cannot accurately identify a country code through a cellular network.

According to a first aspect, an information obtaining method is provided. The method is applicable to a device having a wireless fidelity (wireless-fidelity, Wi-Fi) function. When the terminal device cannot be connected to a cellular network, the method may include:

The terminal device configures information about at least one first channel and a transmit power of each of the at least one first channel;

the terminal device searches for an access point device on a corresponding first channel by using a configured transmit power, and completes an access connection to a found access point device;

the terminal device obtains a current geographic location of the terminal device based on a media access control MAC address of the access point device connected by the terminal device; and

the terminal device obtains corresponding country information (for example, a country code) based on the geographic location, so that the terminal device subsequently configures a transmit power and a channel for Wi-Fi based on the country code.

The terminal device is connected to a network of a wireless access point (access point, AP) device, to obtain the country code, so that the terminal device configures a correct transmit power and a correct channel for Wi-Fi.

In a possible implementation, the terminal device configures the transmit power and the channel for Wi-Fi based on the country information, so that the terminal transmits information by using the correct transmit power and the correct channel of Wi-Fi.

In a possible implementation, the terminal device additionally configures at least one second channel. The method further includes:

The terminal device searches for an access point device on the at least one second channel.

In a possible implementation, that the terminal device completes an access connection to a found access point device includes:

The terminal device selects an access point device; and

when the selected access point device is an access point device found on the at least one first channel, the terminal device completes the access connection to the selected access point device.

In a possible implementation, that the terminal device completes an access connection to a found access point device includes:

The terminal device selects an access point device;

when the selected access point device is not an access point device found on the at least one channel, the terminal device determines whether a quantity of access point devices found on a channel on which the selected access point device operates is greater than a preset threshold; and

when the quantity of access point devices found on the channel on which the selected access point device operates is greater than the preset threshold, the terminal device completes the access connection to the selected access point device.

In a possible implementation, the at least one second channel includes at least one of a channel 12 and a channel 13.

In a possible implementation, the first channel is a channel that meets both Federal Communications Commission FCC and Communate Europeia CE requirements, and the transmit power is a minimum transmit power that meets both the FCC and CE requirements.

According to a second aspect, an information obtaining method is provided. When a terminal device cannot be connected to a cellular network, the method includes:

The terminal device obtains information about a current geographic location of the terminal device through a built-in positioning module; and

the terminal device obtains country information (for example, a country code) based on the geographic location information, so that the terminal device subsequently configures a transmit power and channel list for Wi-Fi based on the country code.

The terminal device obtains the country code by using the built-in GPS module, so that the terminal device configures a correct transmit power and a correct channel for Wi-Fi.

In a possible implementation, the positioning module includes a global positioning system GPS module, a global navigation satellite system GNSS module, or a Beidou navigation satellite module.

In a possible implementation, the method further includes:

The terminal device configures the transmit power and the channel for wireless fidelity Wi-Fi based on the country information, so that the terminal transmits information by using the correct transmit power and the correct channel of Wi-Fi.

According to a third aspect, a terminal device is provided. The terminal device includes a processor and a memory that is configured to store instructions, and the processor is configured to read and execute the instructions in the memory, to implement the following steps: when the terminal device cannot be connected to a cellular network, configuring at least one first channel and a transmit power of each of the at least one first channel;

searching for an access point device on a corresponding first channel by using a configured transmit power, and completing an access connection to a found access point device;

obtaining a current geographic location of the terminal device based on a media access control MAC address of the access point device connected by the terminal device; and

obtaining corresponding country information based on the geographic location.

The terminal device is connected to a network of a wireless access point (access point, AP) device, to obtain a country code, so that the terminal device configures a correct transmit power and a correct channel for Wi-Fi.

In a possible implementation, the processor reads and executes the instructions in the memory, to further implement the following step:

configuring a transmit power and a channel for Wi-Fi based on the country information, so that the terminal transmits information by using the correct transmit power and the correct channel of Wi-Fi.

In a possible implementation, the processor is further configured to additionally configure at least one second channel, and search for an access point device on the at least one second channel.

In a possible implementation, that the processor reads and executes the instructions in the memory, so that the terminal device completes the access connection to the found access point device includes:

The terminal device selects an access point device; and

when the selected access point device is an access point device found on the at least one first channel, the terminal device completes the access connection to the selected access point device.

In a possible implementation, that the processor reads and executes the instructions in the memory, so that the terminal device completes the access connection to the found access point device includes:

The terminal device selects an access point device;

when the selected access point device is not an access point device found on the at least one channel, the terminal device determines whether a quantity of access point devices found on a channel on which the selected access point device operates is greater than a preset threshold; and

when the quantity of access point devices found on the channel on which the selected access point device operates is greater than the preset threshold, the terminal device completes the access connection to the selected access point device.

In a possible implementation, the at least one second channel includes at least one of a channel 12 and a channel 13.

In a possible implementation, the first channel is a channel that meets both Federal Communications Commission FCC and Communate Europeia CE requirements, and the transmit power is a minimum transmit power that meets both the FCC and CE requirements.

According to a fourth aspect, a terminal device is provided. The terminal device includes a processor and a memory that is configured to store instructions, and the processor is configured to read and execute the instructions in the memory, to implement the following steps:

when the terminal device cannot be connected to a cellular network, obtaining, through a positioning module built-in the terminal device, information about a current geographic location of the terminal device; and

obtaining the country information based on the geographic location information, so that the terminal device subsequently configures a transmit power and a channel list for Wi-Fi based on a country code.

In a possible implementation, the positioning module includes a global positioning system GPS module, a global navigation satellite system GNSS module, or a Beidou navigation satellite module.

In a possible implementation, the processor reads and executes the instructions in the memory, to implement the following step:

configuring a transmit power and a channel for wireless fidelity Wi-Fi based on the country information.

According to a fifth aspect, a chip is provided. The chip includes a processor and an interface. The interface is configured to transfer received code instructions to the processor, and the processor is configured to run the code instructions to perform the methods in the first aspect and the second aspect.

Based on the provided information obtaining method and the terminal device, when the terminal device cannot obtain a country code by using a cellular network, the terminal device obtains, based on information about an AP connected by the terminal and GPS location information, a country code of a country in which the terminal device is located, and configures a transmit power and a channel based on the country code, to improve user experience.

### BRIEF DESCRIPTION OF DRAWINGS

FIG. 1 is a schematic flowchart of a method for obtaining a country code by a terminal device;

FIG. 2 is a schematic flowchart of a country code obtaining method according to an embodiment of this application;

FIG. 3 is a schematic flowchart of an information obtaining method according to an embodiment of this application;

FIG. 4 is a schematic diagram of a channel according to an embodiment of this application;

FIG. 5 is a schematic diagram of a scenario according to an embodiment of this application;

FIG. 6(a) is a schematic diagram of an interface in which a terminal device searches for an AP device according to an embodiment of this application;

FIG. 6(b) is a schematic diagram of another interface in which a terminal device is connected to an AP device according to an embodiment of this application;

FIG. 7 is a schematic flowchart of an information obtaining method according to an embodiment of this application;

FIG. 8 is a schematic flowchart of listening on an AP device by a terminal device according to an embodiment of this application;

FIG. 9 is a schematic flowchart of another country code obtaining method according to an embodiment of this application;

FIG. 10 is a schematic diagram of a relationship between a throughput and a transmit power according to an embodiment of this application;

FIG. 11 is a schematic structural diagram of a terminal device according to an embodiment of this application;

FIG. 12 is a schematic structural diagram of another terminal device according to an embodiment of this application; and

FIG. 13 is a schematic diagram of a chip according to an embodiment of this application.

### DESCRIPTION OF EMBODIMENTS

Because different countries require different transmit powers and different channel for Wi-Fi, a terminal device needs to transmit a Wi-Fi signal by using a transmit power and a channel of a corresponding country.

Currently, the terminal device usually obtains, by identifying a cellular network, a country code of a country in which the terminal device is located, and configures a transmit power and a channel of the corresponding country based on the country code. However, the terminal device cannot identify the cellular network in some conditions, for example, when there is no cellular network, or when the terminal device uses a lab network, or when the terminal device is in an airplane mode, where the airplane mode means that a general packet radio service (general packet radio service, GPRS) module in the terminal device (such as a mobile phone, a tablet computer, a smart wearable device, and an AR/VR device) is turned off, so that the terminal device does not actively send a paging signal to a base station.

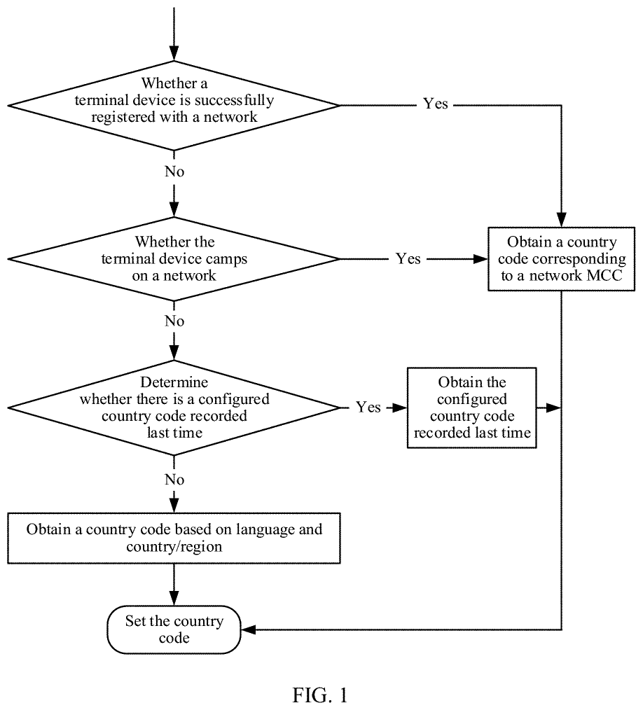

When the terminal device cannot be registered with a network or fails to identify the cellular network by searching, the terminal device usually determines the country code according to the following rule, as shown in FIG. 1.

The terminal device first determines whether the terminal device is successfully registered with the network. If the terminal device is successfully registered with the network, the terminal device obtains a mobile country code (mobile country code, MCC) of the network with which the terminal device is registered. For example, a corresponding MCC country code of China is 460. Then, the terminal device configures a transmit power and a channel for Wi-Fi based on the obtained country code.

If the terminal device fails to be registered with the network, the terminal device further determines whether the terminal device camps on a network. The camping on a network refers to camping on a cell.

Usually, after being powered on, the terminal device searches for a cell based on public land mobile network (public land mobile network, PLMN) information in a subscriber identity module (subscriber identity module, SIM) card or an embedded SIM (embedded SIM, eSIM) card in the terminal device, selects and camps on one cell based on PLMN identifiers, and then initiates, by using initial random access, a call on a control channel of the cell on which the terminal device camps, to complete network registration. When the initial random access is complete, the terminal device is successfully registered with the network, and further transmits data. The PLMN information includes a plurality of PLMN identifiers. The terminal device searches for the cell based on the PLMN identifiers, and selects and camps on one cell.

However, when the terminal device cannot find a suitable cell after being powered on, or when the terminal device does not have a SIM card or an eSIM card, or when the terminal device has a SIM card or an eSIM card but a service is restricted, the terminal device freely selects, without using a PLMN identifier, a cell and camps on the cell, and enters a restricted service state in which only an emergency call can be initiated.

When the terminal device camps on a network, the terminal device selects an MCC of the camping network, and configures a transmit power and a channel for Wi-Fi by using the MCC as a Wi-Fi country code.

When the terminal device does not camp on a network, the terminal device obtains a country code that is recorded last time, and configures a transmit power and a channel for Wi-Fi based on the country code. The country code that is recorded last time is a country code of a country in which the terminal device uses Wi-Fi last time. For example, the terminal device uses Wi-Fi last time in the United States, and a configured country code is a country code of the United States. When the terminal device does not camp on any network and cannot find any network, Wi-Fi is enabled, and the country code configured on the terminal device is still the country code of the United States. In this case, the terminal device configures a transmit power and a channel for Wi-Fi based on the country code of the United States.

When the terminal device does not camp on any network, and does not find any network usage record, the terminal device obtains a country code based on preset “language and country/region” of the terminal device, uses the country code as a country code of a country in which the terminal device is currently located, and configures a transmit power and a channel for Wi-Fi based on the country code, so that the terminal device performs communication by using a correct transmit power and a correct channel.

It can be learned from FIG. 1 that the country code finally determined by the terminal device is not necessarily a country code of a country in which the terminal device is currently located. In other words, according to the rule in FIG. 1, the country code of the country in which the terminal device is located cannot be accurately obtained. Therefore, the embodiments of this application provide an information obtaining method and a terminal device. According to the information obtaining method, the terminal device obtains a geographic location of a country in which the terminal device is located, to accurately obtain a country code, so as to further configure an accurate transmit frequency and an accurate channel for Wi-Fi.

It should be noted that, in the embodiments of this application, information that is obtained by the terminal device by using the information obtaining method may be the country code of the country in which the terminal device is located, or may be other information used for communication by the terminal device. In the embodiments of this application, an example in which the information obtained by the terminal device is the country code is used for description.

The information obtaining method provided in the embodiments of this application is applied to a terminal device having a Wi-Fi function, for example, an electronic device such as a mobile phone, a computer, or a wearable device (such as a smartwatch).

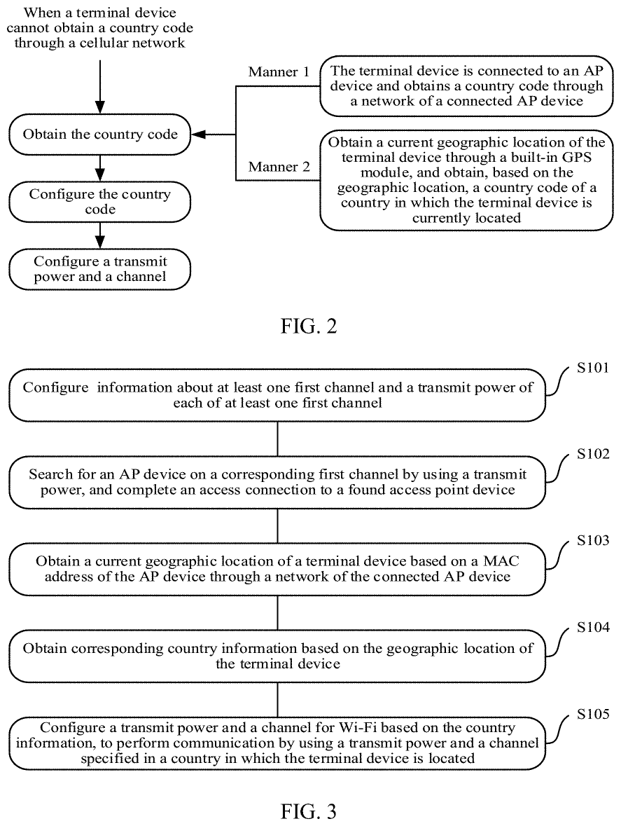

As shown in FIG. 2, in the embodiments of this application, a country code may be accurately obtained in two manners:

Manner 1: When a terminal device cannot obtain a country code through a cellular network, the terminal device is connected to an access point (access point, AP) device such as a router, and then obtains the country code through a network of the connected AP device. The terminal device is connected, by using a Wi-Fi technology, to a local area network covered by the AP device, and therefore, the terminal device is located near the connected AP device, can obtain a current geographic location of the terminal device through the network of the AP device, and can accurately obtain a country code of a country in which the terminal device is currently located. The terminal device may obtain the country code by using the local area network of the connected AP device in the following manner. For example, the terminal device obtains the geographic location of the terminal device by using an internet protocol address (internet protocol address, IP) or media access control (media access control, MAC) address of the AP device, or an operator of the network of the AP device, and further obtains the country code of the country in which the terminal device is located.

Manner 2: When a terminal device cannot obtain a country code through a cellular network, the terminal device may obtain, by using a built-in global positioning system (global positioning system, GPS) module, a current geographic location of the terminal device, and accurately obtain, based on the geographic location, a country code of a country in which the terminal device is currently located.

When the terminal device obtains, through the network of the connected AP device or the built-in GPS module, the country code of the country in which the terminal device is currently located, the terminal device configures the country code, and configures a transmit power and a channel for Wi-Fi based on the country code, so that terminal device performs communication by using a correct transmit power and a correct channel in the country in which the terminal device is located.

The following describes a specific process of obtaining information in the embodiments of this application with reference to the accompanying drawings. It should be noted that “first” and “second” mentioned in the embodiments of this application are merely used to distinguish between objects, and do not limit the objects.

FIG. 3 is a schematic flowchart of an information obtaining method according to an embodiment of this application. The method is executed by a terminal device. As shown in FIG. 3, the method may include the following steps.

S101: Configure at least one first channel and a transmit power of each of the at least one first channel.

The Federal Communications Commission (federal communications commission, FCC) and Communate Europeia (communate europeia, CE) standards and specifications specify Wi-Fi communications requirements for a terminal device in each country, where the requirements include requirements for Wi-Fi communications channel and a transmit power on each channel. To meet the requirements specified in the FCC and CE standards and specifications, the terminal device configures the at least one first channel according to the FCC and CE standards and specifications. The first channel is a channel that meets both the FCC and CE standards and specifications, as shown in FIG. 4. It should be noted that, in FIG. 4, a quantity of channels drawn in the FCC and the CE is merely used for illustration, and does not represent an actual quantity of channels in the FCC and the CE. Channels that meet both the FCC and CE standards and specifications are also merely used as an example, and do not represent actual channels. For the actual channels, refer to the FCC and CE standards and specifications.

The FCC releases a new standard for a 2.4G Wi-Fi terminal device, and a channel 12 and a channel 13 are allowed in the standard. From Jan. 1, 2015, when applying for new FCC IDs, all Wi-Fi terminal devices that support the channel 12 and the channel 13 need to comply with a guidance document KDB 594280 D01 released by the FCC. If the terminal device supports a passive scanning mode and supports the channel 12 and the channel 13 when accessing an AP device, the terminal device may be marketed in advance, and does not need to wait until the new standard is applicable. The guidance document KDB 595280 D01 has the following requirements for the 2.4G Wi-Fi terminal device:

If a 2.4 GHz Wi-Fi terminal device (belonging to the Section 15.247) in the United States can operate on the channel 12 and the channel 13, it is ensured that an output power of the device meets a requirement for out-of-band spurious emissions in the FCC 15.247. In other words, radiated and conducted spurious emissions that are not in a restricted band need to be 20 dBc lower than a dominant wave power, and spurious emissions in the restricted band need to meet a limit of the FCC 15.209.

Whether a terminal device having a Wi-Fi function can operate on the channel 12 and the channel 13 depends on a requirement of the AP device (in the passive scanning mode, when accessing the AP device, the terminal device listens to a data packet sent by the AP device). This terminal device is required to comply with the requirement of the FCC 15.247 regulations in the United States.

The FCC and the CE have different regulatory requirements in countries and regions, and channel lists specified in the FCC and CE standards and specifications are also different. Therefore, the terminal device configures a channel that can meet both FCC and CE channel requirements, for example, a channel 36 that can meet both the FCC and CE channel requirements in 5G. As shown in FIG. 4, 36 is a specified channel number. It should be noted that the channel 36 is only used as an example for description herein. There may be a plurality of channels that meet both the FCC and CE requirements, for example, a channel 1, a channel 2, a channel 3, . . . , a channel 10, a channel 11, a channel 36, . . . , and a channel 165.

In addition, the terminal device configures a transmit power for each configured first channel, and the transmit power configured for the first channel is a minimum transmit power that can meet both FCC and CE requirements. In this case, the configured transmit power is usually a minimum transmit power required by the FCC. For example, in the 802.11b standard, a transmit power of a channel that meets both the FCC and CE standards and specifications is configured to be 17 dBm.

Transmit powers configured by the terminal device for the first channels may be the same or different. In other words, the configured transmit powers of the at least one first channel that are configured by the terminal device and that meet the requirements of the FCC and CE standards and specifications may be the same or different.

S102: Search for an access point device on a corresponding first channel by using a configured transmit power, and complete an access connection to a found access point device.

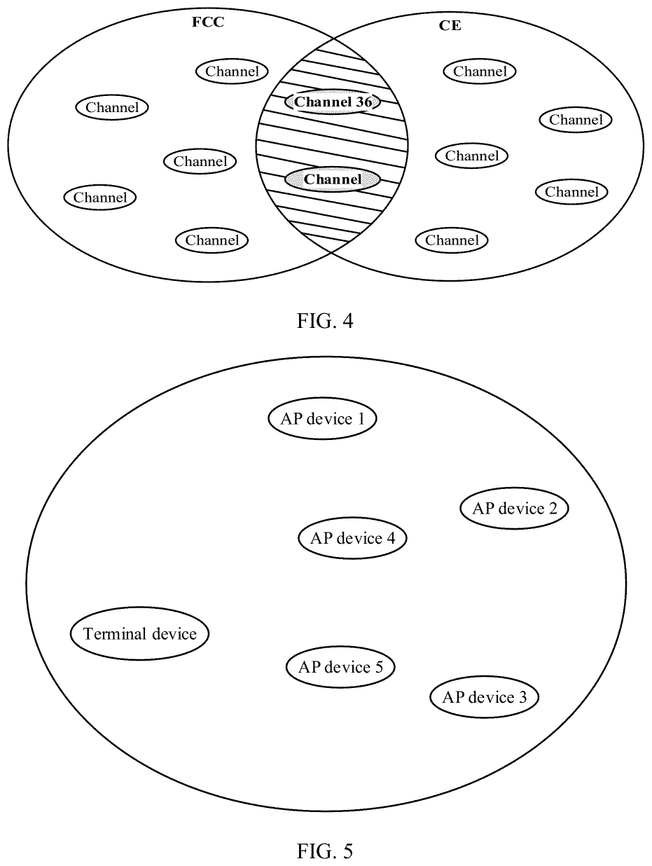

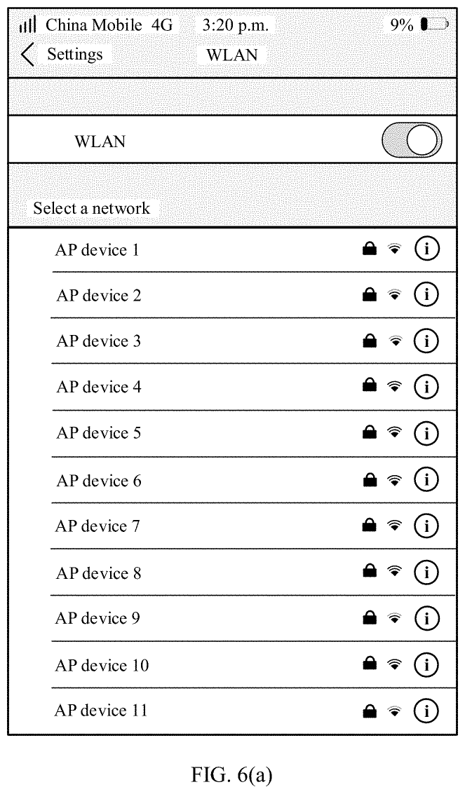

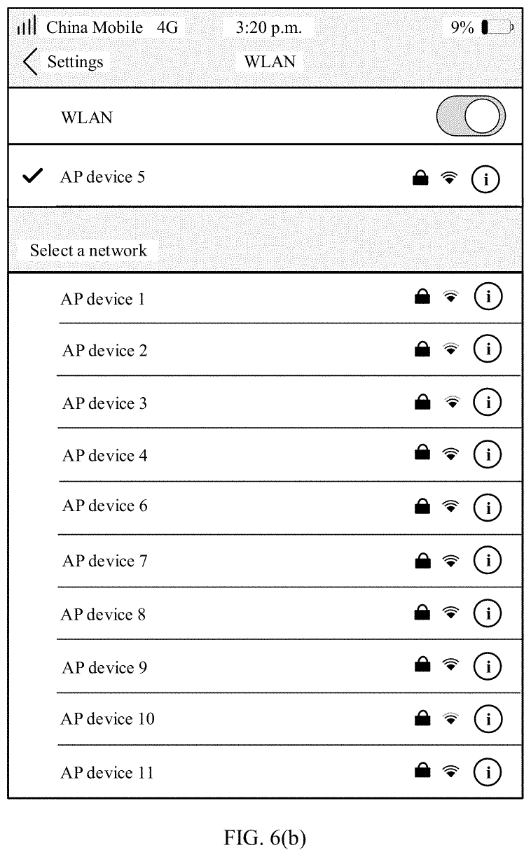

The terminal device searches for an AP device on the corresponding first channel by using the configured transmit power. In an embodiment, within a specific range, there may be a plurality of AP devices near the terminal device, as shown in FIG. 5. Therefore, the terminal device may find a plurality of AP devices on the at least one configured channel, as shown in FIG. 6(a). FIG. 6(a) is described by using an example in which the terminal device is a mobile phone. FIG. 6(a) is a schematic diagram of a list of found AP devices in a wireless network.

Then, the terminal device selects any one of the found AP devices, for example, an AP device 5 found in FIG. 6(a), for connecting to a network, and is connected to the AP device 5. A state after the connection is shown in FIG. 6(b).

S103: Obtain a current geographic location of the terminal device based on a media access control MAC address of the connected AP device.

After being connected to any found AP device, the terminal device is connected to the network through the AP device, obtains the MAC address of the AP device, and sends the obtained MAC address of the AP device to a location server. The location server retrieves a geographic location of the AP device, and returns the geographic location to the terminal device. The location server is a server configured to manage a geographic location of an AP device.

It should be noted that the obtained geographic location of the AP device herein may be approximately considered as the geographic location of the terminal device. The terminal device is connected to a wireless local area network of the AP device, and the terminal device is within a specific distance of the AP device. Therefore, the geographic location of the AP device may be approximately considered as the geographic location of the terminal device.

In addition, the location server cannot manage geographic locations of all AP devices. One reason is that an AP device may be moveable, and if the location server does not update a geographic location of the moved AP device in a timely manner, the location server cannot obtain location information of the AP device. Therefore, the location server needs to continuously update data of a geographic location of the AP device. Certainly, the location server may be unable to manage or accurately manage geographic locations of all AP devices due to other reasons.

In an embodiment, if the terminal device cannot obtain the geographic location of the AP device based on the MAC address of the connected AP device from the location server, the terminal device may obtain geographic locations of one or more found unconnected AP devices from the location server based on MAC addresses of the one or more found unconnected AP devices. A process in which the terminal device obtains the geographic locations of the one or more found unconnected AP devices from the location server based on the MAC addresses of the one or more found unconnected AP devices is the same as a process in which the terminal device obtains the geographic location of the connected AP device from the location server based on the MAC address of the connected AP device. Details are not described again.

Because AP devices that can be found by the terminal are all within a specific distance range from the terminal, an obtained geographic location of an AP device may be considered as the geographic location of the terminal device.

It should be noted that, in this embodiment of this application, considering the geographic location of the AP device as the geographic location of the terminal device does not affect determining the country in which the terminal device is located.

Optionally, in an embodiment, the geographic location of the AP device that is obtained by the terminal device may be specifically latitude and longitude.

S104: Obtain corresponding country information based on the geographic location of the terminal device. The terminal device determines, based on the obtained geographic location of the terminal device, the information about the country in which the terminal device is located. The country information may be a country, a country code corresponding to a country, or other country information used by the terminal device for communication. In this embodiment, the country information is a country code.

In an embodiment, when the geographic location of the AP device that is obtained by the terminal device is the latitude and longitude, the terminal device determines, based on the latitude and longitude of the AP device and a correspondence between a geographic location and a country code, the country code corresponding to the country in which the AP device is located. It should be noted that, in this embodiment, the terminal device presets the correspondence between a geographic location (for example, longitude and latitude) and a country code. For example, if longitude and latitude of a geographic location is 39.9 “North, 116.3” East, a corresponding country code is 460.

Optionally, in another embodiment, the terminal device presets a correspondence between a geographic location, a country, and a country code. When the terminal device determines that the terminal device is located in China based on longitude and latitude of the AP device: 39.9 “North and 116.3” East, the terminal device then determines that a country code corresponding to China is 460.

Optionally, in an embodiment, the terminal device presets a correspondence between a country boundary and longitude and latitude, and sets one or more closed boundaries for each country. The terminal device calculates, by using a ray or another calculation method, whether a point corresponding to the longitude and latitude is in a closed region surrounded by a country boundary. If the point corresponding to the latitude and longitude is in the closed region surrounded by the country boundary, the terminal device converts the longitude and latitude into a country code corresponding to the country.

The terminal device obtains the country code corresponding to the longitude and latitude, and configures a transmit power and a channel for Wi-Fi by using the country code, so that the terminal device performs communication by using the channel and the transmit power that correspond to the country in which the terminal device is located, that is, performs S105.

S105: The terminal device configures the transmit power and the channel for Wi-Fi based on the country information, so that the terminal device performs communication in a corresponding country by using the transmit power and the channel specified in the country.

For example, if a geographic location of the AP device obtained by the terminal device is China, a current location of the terminal device is also China, and a corresponding country code is 460. Channels that can be used are shown in Table 1. In Table 1, channels of a 2.4 GHz band in each country are used as an example for description.

TABLE 1

| | Transmit | | | |
|---|---|---|---|---|
| Channel | frequency | China | US | Europe |
| 1 | 2412 | Yes | Yes | Yes |
| 2 | 2417 | Yes | Yes | Yes |
| 3 | 2422 | Yes | Yes | Yes |
| 4 | 2427 | Yes | Yes | Yes |
| 5 | 2432 | Yes | Yes | Yes |
| 6 | 2437 | Yes | Yes | Yes |
| 7 | 2422 | Yes | Yes | Yes |
| 8 | 2447 | Yes | Yes | Yes |
| 9 | 2452 | Yes | Yes | Yes |
| 10 | 2457 | Yes | Yes | Yes |
| 11 | 2462 | Yes | Yes | Yes |
| 12 | 2467 | Yes | No | Yes |
| 13 | 2472 | Yes | No | Yes |
| 14 | 2484 | No | No | No |

TABLE 2

| | CE | | FCC | |
|---|---|---|---|---|
| | | Transmit | | Transmit |
| | Channel | power | Channel | power |
| 2.4G (11b | 12/13 | 17 dBm | 12/13 | 6 dBm |
| standard) | | | | |
| 5G (11a | 36 | 16 dBm | 36 | 10 dBm |
| standard) | | | | |

Table 2 provides an example of channels and transmit powers used by a 2.4G Wi-Fi terminal device and a 5G Wi-Fi terminal device. The channels and the transmit powers used in specific countries are specified in FCC and CE standards and specifications.

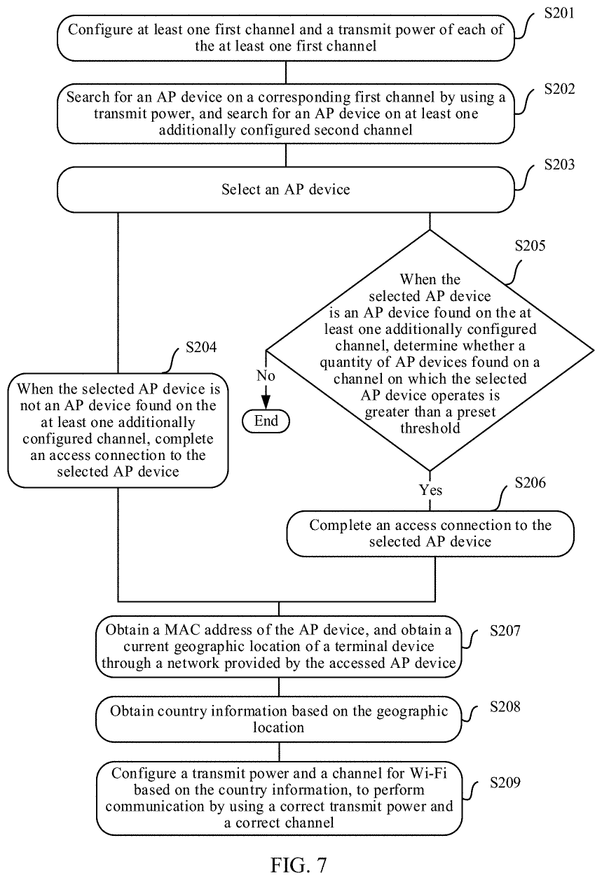

The embodiments of the present invention further provide a schematic flowchart of an information obtaining method. As shown in FIG. 7, the method is executed by a terminal device, and the terminal device is a device having a Wi-Fi function. When the terminal device cannot be connected to a cellular network, the method/step shown in FIG. 7 is performed. A difference between the information obtaining method shown in FIG. 7 and the method shown in FIG. 3 lies in that the terminal device additionally configures at least one second channel, for example, additionally configures a channel 12 and a channel 13. The terminal device searches for an AP device on the additionally configured channel 12 and channel 13, and two channels that meet both FCC and CE channel requirements: a first channel and a second channel (for example, the channel 12 and the channel 13 in an FCC region) by using a configured minimum transmit power that meets both FCC and CE requirements or on at least one additionally configured second channel and a configured minimum channel subset that meets both FCC and CE channel requirements by using a configured minimum transmit power that is configured for the terminal device and that meets both FCC and CE requirements, selects a found AP device to access a network, and completes subsequent steps. Then, the terminal device obtains, from the network based on a MAC address of the connected AP device, information about a current geographic location of the terminal device. A specific process of obtaining the information about the current geographic location of the terminal device is shown in FIG. 7, and may include the following steps.

S201: Configure the at least one first channel and a transmit power of each of the at least one first channel.

To meet requirements that are of a channel and a transmit power used for Wi-Fi communication by a terminal device in each country and that are specified in the FCC and CE standards and specifications, the terminal device configures the at least one first channel according to the FCC and CE standards and specifications. The first channel is a channel that meets both the FCC and CE standards and specifications. The terminal device configures a transmit power for each configured first channel, and the configured transmit power is a minimum transmit power that meets both the FCC and CE requirements, and is usually subject to a minimum transmit power required by the FCC. Transmit powers configured for the first channels may be the same or different.

S202: Search for an AP device on a corresponding first channel by using a configured transmit power, and search for an AP device on the at least one additionally configured second channel.

In an embodiment, the terminal device additionally configures the at least one second channel. The additionally configured second channel may be the channel 12 and the channel 13 that are allowed in a 2.4G Wi-Fi standard released by the FCC, or may be another channel. If the additionally configured second channel is the allowed channel 12 and the allowed channel 13, an output power of a terminal device operating on the channel 12 and the channel 13 needs to meet a requirement of out-of-band spurious emissions specified in the FCC standard. That is, radiated and conducted spurious emissions that do not belong to a restricted band need to be 20 dBc lower than a dominant wave power, and spurious emissions in the restricted band need to meet a restriction in the FCC 15.209.

For example, the at least one additionally configured second channel is two additionally configured channels: the channel 12 and the channel 13, and the terminal device searches for an AP device on the at least one first channel, the channel 12, and the channel 13 that are configured.

In an embodiment, the terminal device may search for an AP device on all channels that meet both the FCC and CE standards and specifications. The all channels mean all channels specified in the FCC and CE standards. In addition, the terminal device searches for an AP device on the additionally configured channel 12 and channel 13, to search for an AP device on all channels.

S203: Select an AP device.

The terminal device randomly selects and determines one from all found AP devices to perform an access connection, so that the terminal device accesses a network of the AP device with a network function. That the terminal device determines an AP device includes: The terminal device selects an AP device from a preset channel, or the terminal device selects an AP device that is first connected, or the terminal device selects an AP device with a strongest signal or best signal quality (best signal quality such as a highest RSSI value, a lowest packet loss rate, and a lowest signal-to-noise ratio).

Before performing the access connection to the AP device, the terminal device determines whether to perform the access connection. A specific process is as follows.

S204: When the selected AP device is not an AP device found on the at least one additionally configured second channel, complete the access connection to the selected AP device.

In other words, the terminal device determines whether the selected AP device is an AP device found on the at least one channel configured in S201. If the selected AP device is an AP device found on the at least one channel configured in S201, the terminal device is connected to the selected AP device. If the selected AP device is not an AP device found on the at least one channel configured in S201, the selected AP device is an AP device found on the at least one additionally configured channel, and S205 is performed.

S205: When the selected AP device is an AP device found on the at least one additionally configured channel, determine whether a quantity of AP devices found on a channel on which the selected AP device operates is greater than a preset threshold.

When the selected AP device is the AP device found on the at least one additionally configured channel, the terminal device determines whether the quantity of AP devices found on the channel on which the selected AP device operates is greater than the preset threshold.

S206: When the quantity of AP devices found on the channel on which the selected AP device operates is greater than the preset threshold, complete the access connection to the selected AP device.

For example, the channels configured in S201 are a channel 1, a channel 2, a channel 3, . . . , and a channel 11. The additionally configured channels are the channel 12 and the channel 13. The terminal device searches for an AP device on the channel 1 to the channel 13, and then selects an AP device 1 from found AP devices (such as an AP device 1, an AP device 2, an AP device 3, . . . ) as the AP device to which the terminal device is to be connected.

When the terminal device determines that the selected AP device 1 is an AP device found on any channel from the channel 1 to the channel 11, the terminal device is connected to the AP device 1.

When the terminal device determines that the selected AP device 1 is an AP device found on the channel 12 or the channel 13, the terminal device determines a quantity of AP devices found on the channel (for example, the channel 12) on which the AP device 1 operates, and determines whether the quantity of AP devices found on the channel 12 is greater than the preset threshold. Assuming that the preset threshold is 3, when the quantity of AP devices found by the terminal device on the channel 12 is greater than the preset threshold 3, it is considered that the country allows communication on the channel 12, and the terminal device can perform communication by using the channel 12, and is connected to the AP device 1.

On the contrary, when the quantity of AP devices found by the terminal device on the channel 12 is less than the preset threshold 3, the terminal device cancels the connection to the AP device 1, and terminates a process of obtaining information (for example, obtaining a country code).

S207: Obtain a MAC address of the AP device connected by the terminal device, and obtain information about a current geographic location of the terminal device based on the MAC address.

When finding the AP device, the terminal device obtains the MAC address of the found AP device, sends the MAC address of the AP device to a location server through a network provided by the connected AP device, and obtains a geographic location of the AP device from the location server.

It should be noted that the obtained geographic location of the AP device herein may be approximately considered as the geographic location of the terminal device. The terminal device is connected to a wireless local area network of the AP device, and the terminal device is within a specific distance of the AP device. Therefore, the geographic location of the AP device may be approximately considered as the geographic location of the terminal device.

Optionally, in an embodiment, the terminal device may obtain the geographic location of the connected AP device from the location server through the network based on the MAC address of the connected AP device.

It should be noted that, because the found AP device is within a specific distance range from the terminal device, it may be considered that the geographic location of the AP device is the geographic location of the terminal device, so that a country in which the terminal device is located may also be accurately determined based on the geographic location of the AP device.

Optionally, in another embodiment, the terminal device may further obtain the geographic location of the AP device from the location server by using the network based on a MAC address or MAC addresses of any found AP device (including the connected AP device) or a plurality of found AP devices.

S208: Obtain corresponding country information based on the geographic location information.

Processes of S207 and S208 in FIG. 7 are similar to processes of S103 and S104 in FIG. 3. For brevity, details are not described herein again.

After obtaining the country code information, the terminal device performs S209: The terminal device configures a transmit power and a channel for Wi-Fi based on the country code, so that the terminal device performs communication by using a correct transmit power and a correct channel.

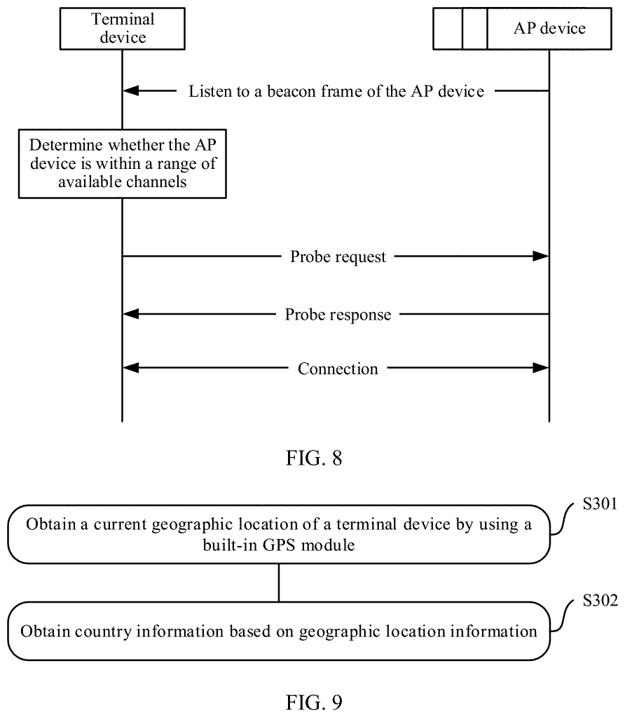

It should be noted that processes in which the terminal device searches for the AP device in FIG. 3 and FIG. 7 may be referred to as listening processes, and the processes are specifically as follows: As shown in FIG. 8, the terminal device listens to a Beacon frame of an AP device, and determines whether the AP device is within a range of available channels. That the terminal device determines whether the AP device is within the range of available channels may specifically be: The terminal device determines whether the AP device detected through listening is a device detected through listening on an additionally configured channel. If the AP device detected through listening is not a device detected through listening on the additionally configured channel, the terminal device is connected to the AP device detected through listening. If the AP device detected through listening is a device detected through listening on the additionally configured channel, the terminal device further determines whether a quantity of all AP devices detected through listening on a channel on which the AP device detected through listening operates is greater than a preset threshold. If the quantity is greater than the preset threshold, the terminal device is connected to the AP device detected through listening. If the quantity is less than or equal to the preset threshold, the terminal device terminates the process of obtaining the country code. That is, the terminal device performs S204 to S207.

When the terminal device determines that the AP device is within the range of available channels, the terminal device sends a probe request (probe request) to the AP device detected through listening, receives a probe response (probe response) sent by the AP device, and then establishes a connection to the AP device.

It should be further noted that the method is further applicable to a case in which the terminal device is in an airplane mode or uses a lab network, so that the terminal device cannot obtain a country code through a cellular network. According to the methods shown in FIG. 3 and FIG. 7, the terminal device can correctly identify a country in which the terminal device is currently located, obtain a country code corresponding to the country, and configure a correct transmit power and a correct channel for Wi-Fi without using a minimum transmit power (for example, a minimum transmit power that meets an FCC requirement). This can increase the transmit power, as shown in Table 3. In the 11b standard, a transmit power in the FCC is 11 dBm and a transmit power in the CE is 17 dbn, and this increases the transmit power by 6 dBm. Transmit powers of the channel 12 and the channel 13 in a CE region (transmit powers of a channel 12 and a channel 13 in an FCC region is very low) do not need to be reduced according to the FCC requirement. Therefore, the transmit powers of the channel 12 and the channel 13 each can be increased by 10 dBm in the 11b standard. It should be noted that in the embodiments of this application, the 11b standard refers to the 802.11b standard, the 11g standard refers to the 802.11g standard, and the 11n standard refers to the 802.11n standard.

TABLE 3

| | CE | FCC | Allowed |
|---|---|---|---|
| | Transmit | Transmit | channel 12/13 |
| | power | power | Transmit |
| Standard | (dBm) | (dBm) | power (dBm) |
| 11b | 17 | 11 | 6 |
| 11g | 17 | 11 | 5 |
| 11n | 16 | 8 | 5 |

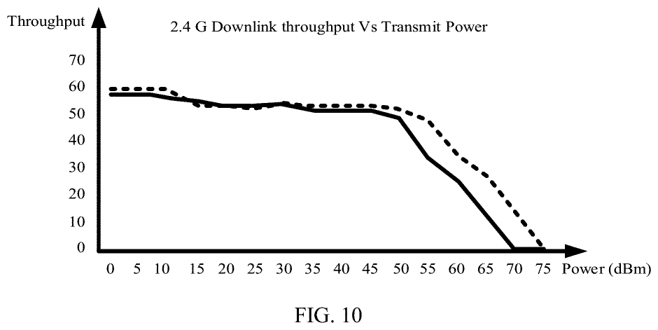

As shown in FIG. 10, it can be learned from a relationship between a throughput and a power that when a received signal strength indication (received signal strength indication, RSSI) is less than −55, a difference of throughputs is about 15 Mbps. In FIG. 10, a dashed line is a throughput when a power is reduced by 5 dBm, and a solid line is a throughput when a power is not reduced.

The embodiments of this application further provide a flowchart of an information obtaining method. As shown in FIG. 9, the method is executed by a terminal device. The terminal device has a Wi-Fi function and has a built-in positioning module, such as a global positioning system (global positioning system, GPS) module, a global navigation satellite system (Global Navigation Satellite System, GNSS) module, or a Beidou navigation satellite module. The positioning module is configured to locate a geographic location of the terminal device.

In this embodiment, an example in which the positioning module is a GPS positioning module is used for description. When the terminal device cannot be connected to a cellular network, the method may include the following steps:

S301: Obtain information about a current geographic location of the terminal device by using the built-in GPS module.

The terminal device locates the current geographic location of the terminal device by using the GPS module.

S302: Obtain country information based on the geographic location.

In an embodiment, the terminal device presets a correspondence between a geographic location and a country code. The terminal device may determine a country code based on the geographic location and the correspondence between a geographic location and a country code, so that the terminal device configures a correct transmit power and a correct channel for Wi-Fi based on the country code.

In an embodiment, the terminal device presets a correspondence between a country boundary and a geographic location (for example, longitude and latitude), and sets one or more closed boundaries for each country. The terminal device may calculate, by using a ray or another calculation method, whether a point corresponding to the longitude and latitude is in a closed region surrounded by a country boundary. In other words, the terminal device determines a country to which a region in which the latitude and longitude is located belongs, and converts the longitude and latitude into a country code of a corresponding country, so that the terminal device sets a correct transmit power and a correct channel for Wi-Fi based on the country code.

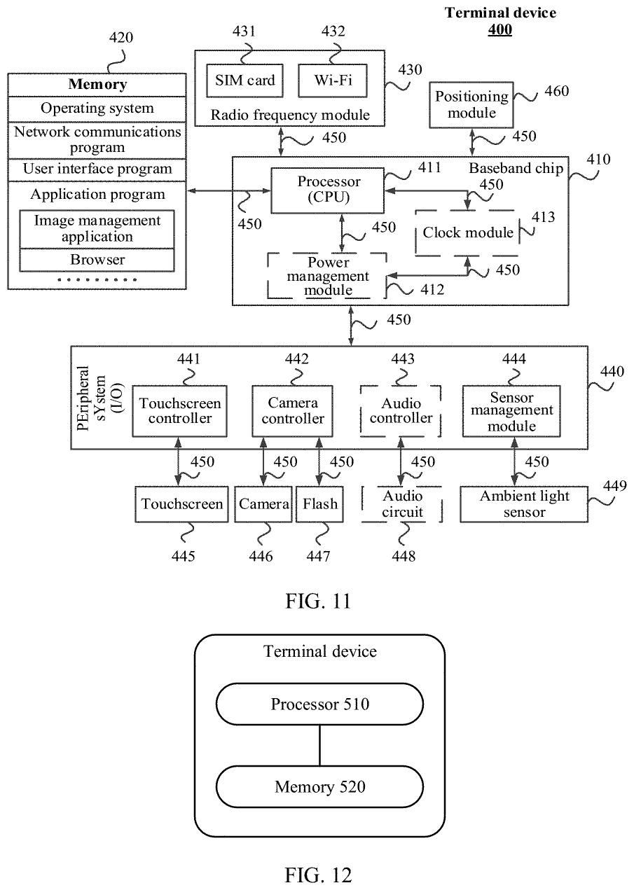

FIG. 1 to FIG. 10 describe the information obtaining methods. The following describes terminal devices provided in the embodiments of this application with reference to FIG. 11 and FIG. 12.

FIG. 11 is a schematic structural diagram of a terminal device according to an embodiment of this application. As shown in FIG. 11, a terminal device 400 may include a baseband chip 410, a memory 420, a radio frequency (radio frequency, RF) module 430, and a peripheral system 440. These components may communicate over one or more communications buses 450. The memory 420 may be one or more computer-readable storage media.

The baseband chip 410 includes one or more processors 411, a power management module 412, and a clock module 413. The clock module 413 integrated in the baseband chip 410 is mainly configured to generate a clock required in data transmission and time sequence control for the processor 411. The power management module 412 integrated in the baseband chip 410 is mainly configured to provide stable and high-precision voltages for the processor 411, the radio frequency module 430, and the peripheral system 440.

The radio frequency module 430 is configured to receive and send a radio frequency signal, and mainly integrates a receiver and a transmitter of the terminal device 400. The radio frequency module 430 may include but is not limited to a SIM card 431, a wireless fidelity Wi-Fi chip 432, and the like. In some embodiments, the radio frequency module 430 may be implemented on a separate chip. Usually, wireless transmission such as Wi-Fi transmission and mobile communications technology (2G, 3G, 4G, 5G, and the like) transmission may be performed through the radio frequency module 430.

The memory 420 is coupled to the processor 411, and is configured to store various software programs and/or instructions. In some embodiments, the memory 420 may include a high-speed random access memory, and may also include a non-volatile memory, such as one or more disk storage devices, a flash device, or another non-volatile solid state storage device. The memory 420 may store an operating system, for example, an embedded operating system such as Android, IOS, Windows, or Linux. The memory 420 may further store a network communications program. The network communications program may be used to communicate with one or more additional devices, terminal devices, and network devices. The memory 420 may further store a user interface program. The user interface program may use a graphical operation interface to visually display content of an application program, and use input controls such as menus, dialog boxes, and keys to receive control operations of a user on the application program.

The memory 420 may further store one or more application programs. As shown in FIG. 11, these application programs may include a social application program (for example, Facebook), an image management application program (for example, album), a map application program (for example, Google map), a browser (for example, Safari or Google Chrome), and the like.

The peripheral system 440 is configured to implement an interaction function between the terminal device 400 and a user/external environment, and may include an input/output apparatus of the terminal device 400, such as a touchscreen controller 441, a camera controller 442, an audio controller 443, and a sensor management module 444. The controllers may be coupled to corresponding peripheral devices, such as a touch display 445, a camera 446, a flash 447, an audio circuit 448, and a sensor 449. It should be noted that the peripheral system 440 may further include another I/O peripheral device.

In some embodiments, the terminal device may further include a positioning module 460. As shown in FIG. 11, the positioning module 460 may be a GPS module, a GNSS module, a Beidou navigation satellite module, or the like. The positioning module 460 is configured to locate a geographic location of the terminal device.

It should be understood that the terminal device 400 is merely an example provided in this embodiment of the present invention. In addition, the terminal device 400 may include components more or fewer than those shown, or may combine two or more components, or may have different component configurations.

FIG. 12 is a schematic structural diagram of another terminal device according to an embodiment of this application. As shown in FIG. 12, the terminal device includes a processor 510. The processor 510 is coupled to a memory, and is configured to read and execute instructions in the memory, to implement the following steps:

when the terminal device cannot be connected to a cellular network, configuring at least one first channel and a transmit power of each of the at least one first channel;

searching for an access point device on a corresponding first channel by using a configured transmit power, and completing an access connection to a found access point device;

obtaining a current geographic location of the terminal device based on a media access control MAC address of the access point device connected by the terminal device; and

obtaining corresponding country information based on the geographic location.

The terminal device is connected to a network of a wireless access point AP device to obtain a country code, so that the terminal device configures a correct transmit power and a correct channel for Wi-Fi.

The terminal device configures the transmit power and the channel for Wi-Fi based on the country information, so that the terminal transmits information by using the correct transmit power and the correct channel of Wi-Fi.

In an embodiment, the processor 510 is further configured to additionally configure at least one second channel, and search for an access point device on the at least one second channel.

In an embodiment, that the processor 510 reads and executes the instructions in the memory, so that the terminal device completes the access connection to the found access point device includes:

The terminal device selects an access point device; and

when the selected access point device is an access point device found on the at least one first channel, the terminal device completes the access connection to the selected access point device.

In an embodiment, that the processor 510 reads and executes the instructions in the memory, so that the terminal device completes the access connection to the found access point device includes:

The terminal device selects an access point device; and

when the selected access point device is not an access point device found on the at least one channel, the terminal device determines whether a quantity of access point devices found on a channel on which the selected access point device operates is greater than a preset threshold; and

when the quantity of access point devices found on the channel on which the selected access point device operates is greater than the preset threshold, the terminal device completes the access connection to the selected access point device.

In an embodiment, the at least one second channel includes at least one of a channel 12 and a channel 13.

In an embodiment, the first channel is a channel that meets both Federal Communications Commission FCC and Communate Europeia CE requirements, and the transmit power is a minimum transmit power that meets both the FCC and CE requirements.

Optionally, in this embodiment, the terminal device further includes a memory 520 that is configured to store instructions and data, for example, a correspondence between longitude and latitude information and a country code.

The embodiments of this application further provide a terminal device. As shown in FIG. 12, the terminal device includes the processor 510. The processor 510 is coupled to a memory, and is configured to read and execute the instructions in the memory, to implement the following steps:

when the terminal device cannot be connected to a cellular network, obtaining, through a positioning module built-in the terminal device, information about a current geographic location of the terminal device; and

obtaining country information based on the geographic location information, so that the terminal device subsequently configures a transmit power and a channel list for Wi-Fi based on a country code.

In an embodiment, the positioning module may be one of a global positioning system GPS module, a global navigation satellite system GNSS module, or a Beidou navigation satellite module.

In an embodiment, the processor reads and executes the instructions in the memory, to implement the following step:

configuring the transmit power and the channel for wireless fidelity Wi-Fi based on the country information.

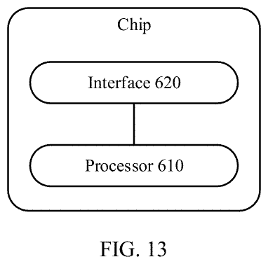

The embodiments of this application further provide a chip. As shown in FIG. 13, the chip includes a processor 610 and an interface 620. The interface 620 is configured to transfer received code instructions to the processor 610, and the processor 610 is configured to run the code instructions to perform the following steps:

when a terminal device cannot be connected to a cellular network, configuring at least one first channel and a transmit power of each of the at least one first channel;

searching for an access point device on a corresponding first channel by using a configured transmit power, where the terminal device completes an access connection to a found access point device;

obtaining a current geographic location of the terminal device based on a media access control MAC address of the access point device connected by the terminal device; and

obtaining corresponding country information based on the geographic location.

Further, the processor 610 may be further configured to run the code instructions to perform the following step:

configuring a transmit power and a channel for Wi-Fi based on the country information, to configure, for the terminal device, a correct transmit power and a correct channel for Wi-Fi.

Optionally, in an embodiment, the processor 610 may be further configured to run the code instructions to perform the following step:

additionally configuring at least one second channel, and searching for an access point device on the at least one second channel.

Optionally, in an embodiment, that the processor 610 runs the code instructions, so that the terminal device completes the access connection to the found access point device includes:

The terminal device selects an access point device;

when the selected access point device is an access point device found on the at least one first channel, the terminal device completes the access connection to the selected access point device;

when the selected access point device is not an access point device found on the at least one channel, the terminal device determines whether a quantity of access point devices found on a channel on which the selected access point device operates is greater than a preset threshold; and

when the quantity of access point devices found on the channel on which the selected access point device operates is greater than the preset threshold, the terminal device completes the access connection to the selected access point device.

Optionally, in an embodiment, the at least one second channel includes at least one of a channel 12 and a channel 13.

Optionally, in an embodiment, the first channel is a channel that meets both Federal Communications Commission FCC and Communate Europeia CE requirements, and the transmit power is a minimum transmit power that meets both the FCC and CE requirements.

A function of the chip may implement the steps performed by the terminal device in FIG. 3 and FIG. 7. Therefore, a specific working process of the chip provided in this embodiment of this application is not described herein again.

The embodiments of this application further provide a chip. As shown in FIG. 13, the chip includes a processor 610 and an interface 620. The interface 620 is configured to transfer received code instructions to the processor 610, and the processor 610 is configured to run the code instructions to perform the following steps:

when the terminal device cannot be connected to a cellular network, obtaining, through a positioning module built-in the terminal device, information about a current geographic location of the terminal device; and

obtaining the country information based on the geographic location information, so that the terminal device subsequently configures a transmit power and a channel list for Wi-Fi based on a country code.

Optionally, in an embodiment, the positioning module includes a global positioning system GPS, a global navigation satellite system GNSS module, or a Beidou navigation satellite module.

Optionally, in an embodiment, the processor 610 reads and executes the instructions in the memory, to implement the following step:

configuring the transmit power and the channel for wireless fidelity Wi-Fi based on the country information.

A function of the chip may implement steps performed by the terminal device in FIG. 9. Therefore, the specific working process of the chip provided in this embodiment of this application is not described herein again.

All or some of the foregoing embodiments of the present invention may be implemented by using software, hardware, firmware, or any combination thereof. When the embodiments are implemented by using the software, all or some of the embodiments may be implemented in a form of a computer program product. The computer program product includes one or more computer instructions. When the computer program instructions are loaded and executed on a computer, the procedures or functions according to the embodiments of the present invention are completely or partially generated. The computer may be a general-purpose computer, a dedicated computer, a computer network, or other programmable apparatuses. The computer instructions may be stored in a computer-readable storage medium or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (Digital Subscriber Line, DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a DVD), a semiconducting medium (for example, a solid state drive (Solid State Disk, SSD)), or the like.

The foregoing descriptions are merely specific implementations of the present invention, but are not intended to limit a protection scope of the present invention. Any variation or replacement readily figured out by a person skilled in the art within a technical scope disclosed in the present invention shall fall within the protection scope of the present invention. Therefore, the protection scope of the present invention shall be subject to the protection scope of the claims.

1. A method implemented by a terminal device, wherein the method comprises:
configuring a first channel and a first transmit power of the first channel when the terminal device cannot be connected to a cellular network;
searching, using the first transmit power, for a first access point device on the first channel;
completing a first access connection to the first access point device;
obtaining a current geographic location of the terminal device based on a media access control (MAC) address of the first access point device; and
obtaining country information based on the current geographic location.

2. The method of claim 1, further comprising configuring, based on the country information, a second transmit power and a second channel for a WI-FI function of the terminal device.

3. The method of claim 1, further comprising:
configuring a second channel; and
searching for a second access point device on the second channel.

4. The method of claim 3, further comprising:
selecting a third access point device; and
completing a second access connection to the third access point device when the third access point device is on the first channel.

5. The method of claim 3, further comprising:
selecting a third access point device;
determining whether a quantity of available access point devices on a third channel on which the third access point device operates is greater than a preset threshold when the third access point device is not on the first channel; and
completing a second access connection to the third access point device when the quantity is greater than the preset threshold.

6. The method of claim 3, wherein the second channel comprises at least one of a channel 12 or a channel 13.

7. The method of claim 1, wherein the first channel meets both Federal Communications Commission (FCC) requirements and Communate Europeia (CE) requirements, and wherein the first transmit power is a minimum transmit power that meets both the FCC requirements and the CE requirements.

8. A terminal device comprising:
a memory configured to store instructions; and
a processor coupled to the memory, wherein the instructions cause the processor to be configured to:
configure a first channel and a first transmit power of the first channel when the terminal device cannot be connected to a cellular network;
search, using the first transmit power, for a first access point device on the first channel;
complete a first access connection to the first access point device;
obtain a current geographic location of the terminal device based on a media access control (MAC) address of the first access point device; and
obtain country information based on the current geographic location.

9. The terminal device of claim 8, wherein the instructions further cause the processor to be configured to configure, based on the country information, a second transmit power and a second channel for a WI-FI function of the terminal device.

10. The terminal device of claim 8, wherein the instructions further cause the processor is to be configured to:
configure a second channel; and
search for a second access point device on the second channel.

11. The terminal device of claim 10, wherein the instructions further cause the processor to be configured to:
select a third access point device; and
complete a second access connection to the third access point device when the third access point device is on the first channel.

12. The terminal device of claim 10, wherein the instructions further cause the processor to be configured to:
select a third access point device;
determine whether a quantity of available access point devices on a third channel on which the third access point device operates is greater than a preset threshold when the third access point device is not on the first channel; and
complete a second access connection to the third access point device when the quantity is greater than the preset threshold.

13. The terminal device of claim 10, wherein the second channel comprises at least one of a channel 12 or a channel 13.

14. The terminal device of claim 8, wherein the first channel meets both Federal Communications Commission (FCC) requirements and Communate Europeia (CE) requirements, and wherein the first transmit power is a minimum transmit power that meets both the FCC requirements and the CE requirements.

15. A computer program product comprising computer-executable instructions stored on a non-transitory computer-readable medium that, when executed by a processor, cause a terminal device to:
configure a first channel and a first transmit power of the first channel when the terminal device cannot be coupled to a cellular network;
search, using the first transmit power, for a first access point device on the first channel;
complete a first access connection to the first access point device;
obtain a current geographic location of the terminal device based on a media access control (MAC) address of the first access point device; and
obtain corresponding country information based on the current geographic location.

16. The computer program product of claim 15, wherein the computer-executable instructions further cause the terminal device to configure a second transmit power and a second channel for a WI-FI function of the terminal device.

17. The computer program product of to claim 15, wherein the computer-executable instructions further cause the terminal device to:
configure a second channel; and
search for a second access point device on the second channel.

18. The computer program product of claim 17, wherein the computer-executable instructions further cause the terminal device to:
select a third access point device; and
complete a second access connection to the third access point device when the third access point device is on the first channel.

19. The computer program product of claim 17, wherein the computer-executable instructions further cause the terminal device to:
select a third access point device;
determine whether a quantity of available fourth access point devices on a third channel on which the third access point device operates is greater than a preset threshold when the third access point device is not on the first channel; and
complete a second access connection to the third access point device when the quantity is greater than the preset threshold.

20. The computer program product of claim 17, wherein the second channel comprises at least one of a channel 12 or a channel 13.

21. (canceled)
